(19) United States
(12) Patent Application Publication
(10) Pub. No.: US 2009/0290814 A1
(43) Pub. Date: Nov. 26, 2009

(54) IMAGE COMPENSATION APPARATUS AND METHOD

(76) Inventor: Sin Sung YOO, Seoul (KR)

Correspondence Address: KED & ASSOCIATES, LLP, P.O. Box 221200, Chantilly, VA, 20153-1200, US

(21) Appl. No.: 12/177,480

(22) Filed: Jul. 22, 2008

Related U.S. Application Data
(60) Provisional application No. 61/054,819, filed on May 21, 2008.

(51) Int. Cl. G06K 9/54

(52) U.S. Cl. 382/305

(57) ABSTRACT

An image compensation apparatus and method for compensating an image scanned using a micro scanning mirror is disclosed. The disclosed image correction apparatus includes a transform/storage unit for storing an original image consisting of image data having an M-row×N-column size, the transform/storage unit laterally reversing an order of the image data at intervals of one row, upon storing the original image, and storing the resultant image data of the original image, and a micro scanning mirror for horizontally scanning the image data read out from the transform/storage unit.

This application claims the benefit of U.S. Provisional Patent Application No. 61/054,819, filed on May 21, 2008, which is hereby incorporated by reference as if fully set forth herein.

### BACKGROUND OF THE INVENTION

1. Field of the Invention

The present invention relates to fields using a micro scanning mirror, and more particularly to an image compensation apparatus and method for compensating an image scanned using a micro scanning mirror.

2. Discussion of the Related Art

Recently, a display system, which scans a desired image, using a micro electromechanical system (MEMS) mirror, while using a laser as a light source, has been developed. Hereinafter, the MEMS mirror will be referred to as a “micro scanning mirror”.

It is possible to create a two-dimensional screen by scanning a laser beam from a laser by use of a micro scanning mirror while using the laser as a light source. If a laser beam is scanned onto a screen, using an electron gun, as in a cathode ray tube (CRT), it is possible to control the scanning operation through desired motions of the electron gun. However, the micro scanning mirror can only conduct a simple reciprocation because it is driven using a resonance mode.

In a horizontal image scanning operation in the CRT system, the electron gun rapidly returns from the right to the left after conducting the scanning operation in a direction from the left to the light, and then again conducts the scanning operation from the left to the right. However, where an image is scanned in a horizontal direction, using the micro scanning mirror, the speed, at which the micro scanning mirror conducts a scanning operation from the left to the right, is equal to the speed, at which the micro scanning mirror returns from the right to the left. For this reason, if the micro scanning mirror conducts the scanning operation only in a direction from the left to the right, without conducting the scanning operation during the return from the right to the left, as in conventional CRTs, there is a problem of a degradation in image brightness.

Meanwhile, in a vertical image scanning operation in the CRT system, the electron gun rapidly returns in an upward direction after conducting the scanning operation in a downward direction, and then again conducts the scanning operation in the upward direction. However, where an image is scanned in a vertical direction, using the micro scanning mirror, the speed, at which the micro scanning mirror conducts a scanning operation in the downward direction, is equal to the speed, at which the micro scanning mirror returns in the upward direction. This is because the micro scanning mirror should reciprocate in a resonance mode. For this reason, if the micro scanning mirror conducts the scanning operation only in the downward direction, without conducting the scanning operation during the return in the upward direction, as in conventional CRTs, there is a problem of a degradation in image brightness.

### SUMMARY OF THE INVENTION

Accordingly, the present invention is directed to an image compensation apparatus and method that substantially obviates one or more problems due to limitations and disadvantages of the related art.

An object of the present invention is to provide an image compensation apparatus and method capable of compensating an image for a degradation in brightness occurring possibly in an image scanning operation using a micro scanning mirror.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an image correction apparatus comprises: a transform/storage unit for storing an original image consisting of image data having an M-row×N-column size, the transform/storage unit laterally reversing an order of the image data at intervals of one row, upon storing the original image, and storing the resultant image data of the original image; and a micro scanning mirror for scanning the image data read out from the transform/storage unit.

In accordance with another aspect of the present invention, an image correction apparatus comprises: a transform/storage unit for storing an original image consisting of image data having an M-row×N-column size, together with a symmetrical image vertically symmetrical with the original image; and a micro scanning mirror for scanning the image data read out from the transform/storage unit.

In accordance with another aspect of the present invention, an image correction apparatus comprises: a video signal processor for processing an original image consisting of image data having an M-row×N-column size such that an order of the image data is reversed at intervals of at least one row; and a light source for outputting an image in accordance with results of the processing of the video signal processor.

In accordance with another aspect of the present invention, an image correction method carried out in an image correction apparatus adapted to scan image data using a micro scanning mirror comprises: storing an original image consisting of image data having an M-row×N-column size after laterally reversing an order of the image data at intervals of one row; and horizontally scanning the stored image data.

In accordance with another aspect of the present invention, an image correction method carried out in an image correction apparatus adapted to scan image data using a micro scanning mirror comprises: storing an original image consisting of image data having an M-row×N-column size, together with a symmetrical image vertically symmetrical with the original image; and vertically scanning the stored image data.

In accordance with another aspect of the present invention, an image correction method comprises: storing an original image consisting of image data having an M-row×N-column size such that an order of the image data is reversed at intervals of at least one row; and outputting the image data of the stored image to a light source.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram generally and schematically illustrating an imaging apparatus configured to scan an image, using a micro scanning mirror;

FIG. 2 is a block diagram of an image compensation apparatus according to an exemplary embodiment of the present invention;

FIG. 3 is a flow chart for explaining an image correction method according to an exemplary embodiment of the present invention;

FIGS. 4A to 4C are schematic views for explaining the operations of elements in the apparatus shown in FIG. 2;

FIG. 5 is a general timing diagram of a VESA monitor;

FIG. 6 is a flow chart for explaining an image correction method according to another embodiment of the present invention; and

FIGS. 7A to 7C are schematic views for explaining the operations of the elements in the apparatus shown in FIG. 2.

### DETAILED DESCRIPTION OF THE INVENTION

Reference will now be made in detail to the preferred embodiments of the present invention, examples of which are illustrated in the accompanying drawings.

The present invention may, however, be embodied in many alternate forms and should not be construed as limited to the embodiments set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

It will be understood that although the terms first and second are used herein to describe various regions, layers and/or sections, these regions, layers and/or sections should not be limited by these terms.

An example, in which a micro scanning mirror is used, will be described with reference to the accompanying drawings, before the description of an image compensation apparatus according to the present invention.

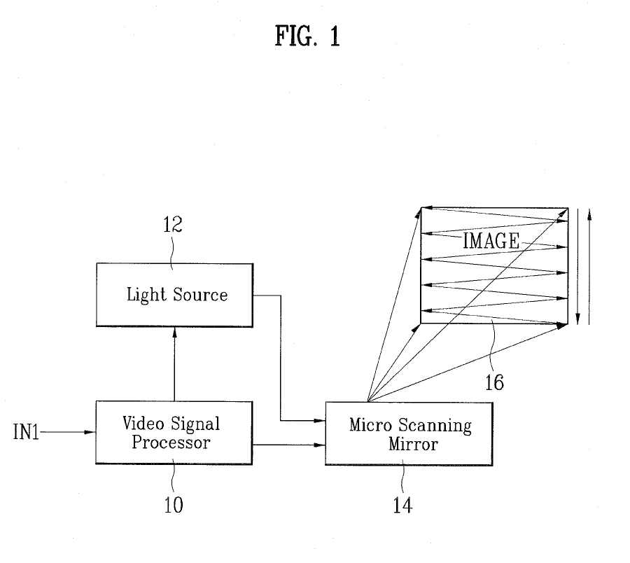

FIG. 1 is a block diagram generally and schematically illustrating an imaging apparatus configured to scan an image, using a micro scanning mirror. The imaging apparatus includes a video signal processor 10, a light source 12, a micro scanning mirror 14, and a screen 16.

As shown in FIG. 1, the video signal processor 10 processes a video signal input through an input terminal IN1, and outputs the result of the processing to the light source 12, as a control signal. In response to the control signal from the video signal processor 10, the light source 12 outputs corresponding light to the micro scanning mirror 14. Where a laser is used as the light source 12, a laser beam, which is emitted from the light source 12, is reflected by the micro scanning mirror 14 such that it is scanned onto the screen 16.

Hereinafter, the configuration and operation of an image compensation apparatus according to an exemplary embodiment of the present invention and an image compensation method carried out in the image compensation apparatus will be described with reference to the accompanying drawings.

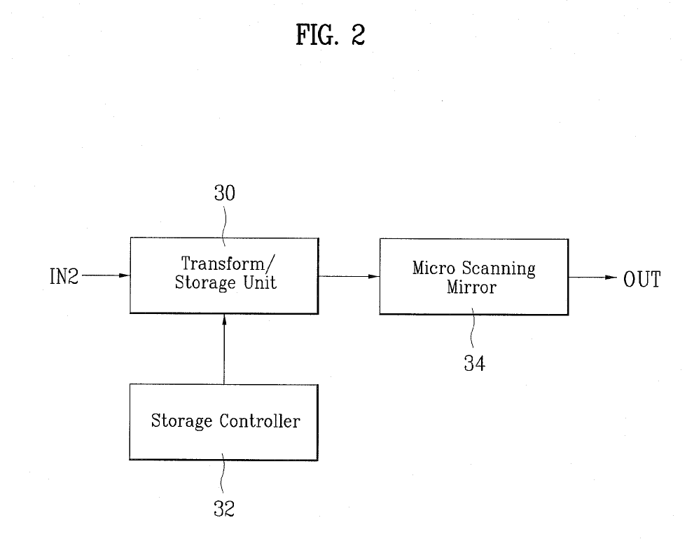

FIG. 2 is a block diagram of the image compensation apparatus according to the illustrated embodiment of the present invention. The image compensation apparatus includes a transform/storage unit 30, a storage controller 32, and a micro scanning mirror 34.

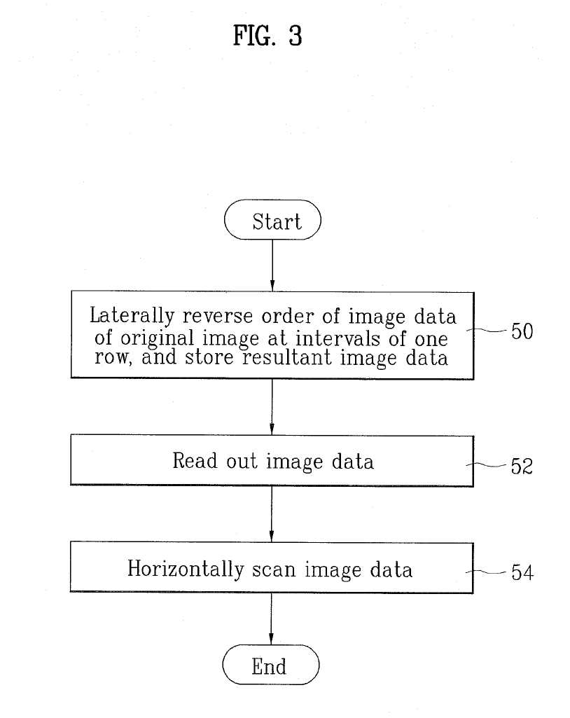

FIG. 3 is a flow chart for explaining an image correction method according to an exemplary embodiment of the present invention. The image correction method includes the steps of storing image data in rows of an original image while laterally reversing the order of the image data at intervals of one row (Step 50), reading out the image data (Step 52), and scanning the read image data (Step 54).

In accordance with the present invention, the transform/storage unit 30 receives an original image consisting of M×N image data input through an input terminal IN2 (Step 50). At step 50, the transform/storage unit 30 laterally reverses the order of image data at intervals of at least one row, and stores the laterally-reversed image data. For example, the transform/storage unit 30 may laterally reverse the order of image data at intervals of a plurality of rows, or at intervals of one row.

When the transform/storage unit 30 laterally reverses the order of image data at intervals of one row, it can store the original image after laterally reversing the order of the image data of each even row. On the other hand, in accordance with another embodiment of the present invention, the transform/storage unit 30 may store the original image after laterally reversing the order of the image data of each odd row.

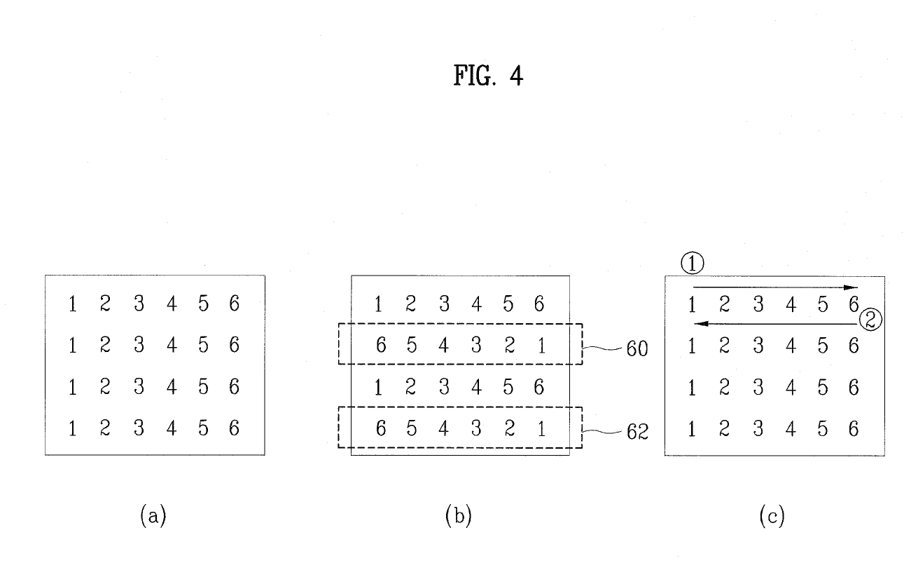

FIGS. 4A to 4C are schematic views for explaining the operations of the elements in the apparatus shown in FIG. 2. FIG. 4A illustrates an original image input through the input terminal IN2. FIG. 4B illustrates an image stored in the transform/storage unit 30 after being transformed from the original image. FIG. 4C illustrates a scanned image.

The transform/storage unit 30 may receive an original image, which consists of M×N image data (M=4, and N=6), as shown in FIG. 4A, via the input terminal IN2, and may then store the original image. In this case, the transform/storage unit 30 may store the original image after laterally reversing the order of image data in even rows 60 and 62, as shown in FIG. 4B.

After the execution of step 50, the storage controller 32 reads out, in a direction from the left to the right, the image data of an m-th row (1≦m≦M) in the image stored in the transform/storage unit 30, and outputs the read image data to the micro scanning mirror 34 (Step 52). Thereafter, the storage controller 32 reads out, in the direction from the left to the right, the image data of an m+1-th row in the image stored in the transform/storage unit 30, and outputs the read image data to the micro scanning mirror 34. Subsequently, the storage controller 32 reads outs the image data of an m+2-th row in the stored image in the direction from the left to the right, and outputs the read image data to the micro scanning mirror 34. Thus, the storage controller 32 reads out image data in a horizontal direction from the left to the right, and outputs the read image data to the micro scanning mirror 34.

For example, as shown in FIG. 4B, the storage controller 32 reads out the image data of the first row in the direction from the left to the right, and outputs the read image data to the micro scanning mirror 34. Thereafter, the storage controller 32 reads out the image data of the second row 60 in the direction from the left to the right, and outputs the read image data to the micro scanning mirror 34. After the reading and outputting of the image data of the second row 60, the storage controller 32 reads out the image data of the third row in the direction from the left to the right, and outputs the read image data to the micro scanning mirror 34. After the reading and outputting of the image data of the third row, the storage controller 32 reads out the image data of the fourth row 62 in the direction from the left to the right, and outputs the read image data to the micro scanning mirror 34.

After the execution of step 52, the micro scanning mirror 34 horizontally scans the image data read from the transform/storage unit 30 under the control of the storage controller 32 (Step 54). For example, when the original image stored in the transform/storage unit 30, as shown in FIG. 4B, is read out under the control of the storage controller 32 in the above-described manner, the micro scanning mirror 34 may sequentially scan, as shown in FIG. 4C, the image data in the first row, namely, the image data of ‘1’, ‘2’, ‘3’, ‘4’, ‘5’, and ‘6’ in a direction indicated by an arrow \textcircled{1}, and may then sequentially scan the image data in the second row, namely, the image data of ‘6’, ‘5’, ‘4’, ‘3’, ‘2’, and ‘1’ in a direction indicated by an arrow \textcircled{2}. Thus, in accordance with the present invention, there is no degradation in image brightness because the image data of the m+1-th row can be scanned in a direction from the right to the left, after the scanning of the image data of the m-th row in a direction from the left to the right.

Meanwhile, the method of storing and scanning an original image in the horizontal scanning mode can be applied to the vertical scanning mode in the same manner. That is, in the vertical scanning mode, the order of the image data in the original image is vertically reversed at intervals of at least one column, and the vertically-reversed image data is then stored. The vertically-reversed image data may be read out, and then sequentially scanned in a vertical direction determined in accordance with the column thereof, namely, in a downward direction or in an upward direction. Accordingly, there is no degradation in image brightness.

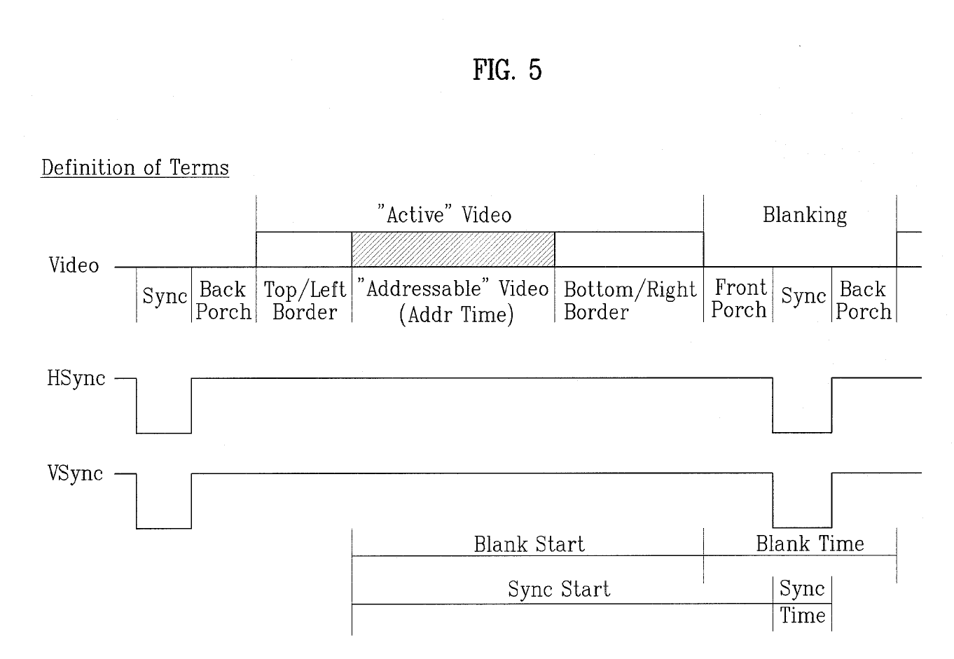

FIG. 5 is a general timing diagram of a VESA monitor. The period of a video signal applied to the VESA monitor consists of an “active” video period and a blanking period.

In a scanning operation carried out using a conventional CRT, scanning of an image is conducted in a direction from the left to the right in the active video period, and a returning operation is conducted in a direction from the right to the left in the blanking period. However, where the micro scanning mirror 34 is used, the length of the active video period and the length of the blanking period are equal, as shown in FIG. 5. Therefore, in accordance with the present invention, it is possible to continuously scan image data without stopping in such a manner that the image data of an m-th row is scanned in a direction from the left to the right in the active video period, whereas the image data of an m+1-th row is scanned in a direction from the right to the left. That is, the image data stored in the transform/storage unit 30 after being laterally reversed is read out under the control of the storage controller 32, and is then scanned by the micro scanning mirror 34 in the blanking period.

In the image correction apparatus and method according to the present invention, image data is scanned in a horizontal direction, using the micro scanning mirror 34, as described above. However, the present invention is not limited to the illustrated image correction apparatus and method. That is, the present invention may be implemented using a configuration different from that of FIG. 2. For example, the image correction apparatus of the present invention shown in FIG. 2 may dispense with the storage controller 32, as long as it is possible to continuously scan image data without stopping in such a manner that the image data of one row is scanned in a direction from the left to the right, and the image data of a next row is scanned in a direction from the right to the left. In this case, the image correction method shown in FIG. 3 dispenses with step 52. Also, the image correction apparatus of the present invention shown in FIG. 2 may dispense with the storage controller 32, as long as it is possible to continuously scan image data without stopping in such a manner that the image data of one row is scanned in a direction from the right to the left, and the image data of a next row is scanned in a direction from the left to the right. In this case, the image correction method shown in FIG. 3 dispenses with step 52.’

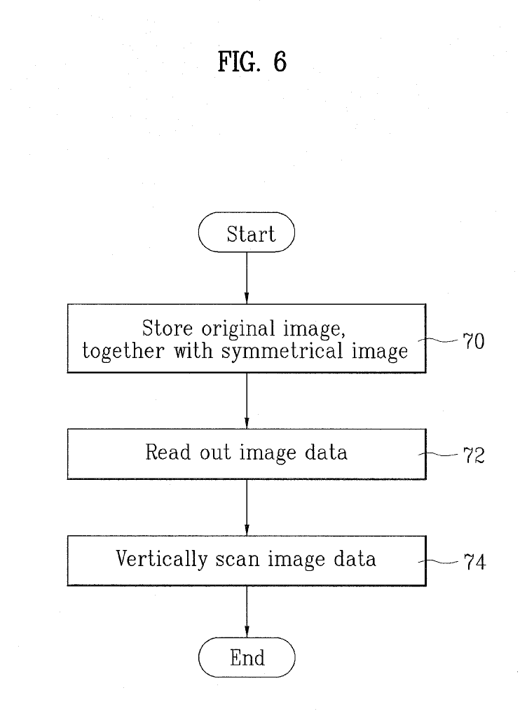

FIG. 6 is a flow chart for explaining an image correction method according to another embodiment of the present invention. This image correction method includes the steps of storing an original image, together with an image symmetrical to the original image (Step 70), reading out the stored image data (Step 72), and scanning the read image data (Step 74).

In accordance with the present invention, the transform/storage unit 30 receives an original image consisting of image data having an M×N size, together with an image symmetrical with the original image (Step 70). Here, the symmetrical image (or a mirror image) means an image vertically symmetrical with the original message. That is, in accordance with the present invention, the transform storage unit 30 transforms the original image, which consists of image data having an M×N size, into a symmetrical image. Thereafter, the transform storage unit 30 stores the symmetrical image, which consists of image data having an M×N size, beneath the original image such that the symmetrical image is vertically parallel to the original image while being adjacent to the original image.

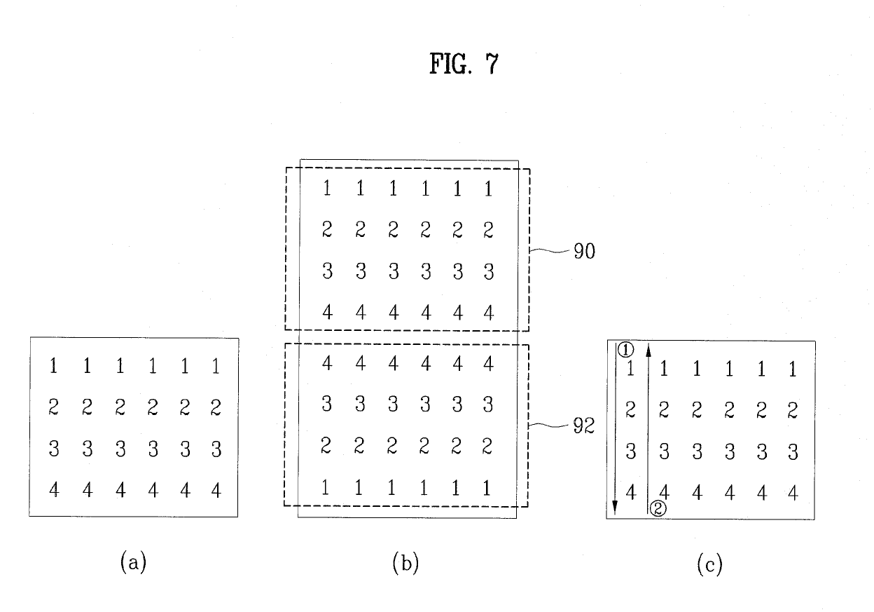

FIGS. 7A to 7C are schematic views for explaining the operations of the elements in the apparatus shown in FIG. 2. FIG. 7A illustrates the original image. FIG. 7B illustrates the original image and the symmetrical image, which are stored in the transform storage unit 30. FIG. 7C illustrates a scanned image.

The transform/storage unit 30 may receive an original image 90, which consists of M×N image data (M=4, and N=6), as shown in FIG. 7A, via the input terminal IN2, and may then transform the original image into a symmetrical image 92, as shown in FIG. 7B. The transform/storage unit 30 may then store the original image 90 and the symmetrical image 92, as shown in FIG. 7B. That is, the transform/storage unit 30 stores the symmetrical image 92, which consists of image data having a 4×6 size, beneath the original image 90, which consists of image data having a 4×6 size, such that the symmetrical image 92 is vertically parallel to the original image 90 while being adjacent to the original image 90.

After the execution of step 70, the storage controller 32 reads out, in a downward direction, the image data of an n-th column (1≦n≦N) in the image stored in the transform/storage unit 30, and outputs the read image data to the micro scanning mirror 34. Thereafter, the storage controller 32 reads out, in the downward direction, the image data of an n+1-th column in the image stored in the transform/storage unit 30, and outputs the read image data to the micro scanning mirror 34 (Step 72).

The storage controller 32 reads out, in a downward direction, the image data of an n-th column (1≦n≦N) in the image stored in the transform/storage unit 30, and outputs the read image data to the micro scanning mirror 34. Thereafter, the storage controller 32 reads out, in the downward direction, the image data of an n+1-th column in the image stored in the transform/storage unit 30, and then outputs the read image data to the micro scanning mirror 34 (Step 72). Alternatively, the storage controller 32 may read out, in an upward direction, the image data of the n-th column (1≦n≦N) in the image stored in the transform/storage unit 30, and may output the read image data to the micro scanning mirror 34. Thereafter, the storage controller 32 may read out, in the upward direction, the image data of an n+1-th column in the image stored in the transform/storage unit 30, and may then output the read image data to the micro scanning mirror 34. Although it is desirable for image data of the columns to be always read out in the same direction, the present invention is not limited thereto.

Where both the original image 90 and the symmetrical image 92 are stored in the storage unit 30, as shown in FIG. 7B, the storage controller 32 reads out the image data of the first column in a downward direction, and then sequentially reads out the image data of the second to sixth columns in the same direction as that of the first column, namely, the downward direction. That is, the storage controller 32 reads out the image data of the second column as shown in FIG. 7B in the downward direction, and then reads out the image data of the third column in the downward direction. After the reading of the image data of the third column, the storage controller 32 reads out the image data of the fourth column. This operation is repeated for subsequent columns.

After the execution of step 72, the micro scanning mirror 34 vertically scans the image data read from the transform/storage unit 30 (Step 74).

For example, when the original image 90 and symmetrical image 92 stored in the transform/storage unit 30, as shown in FIG. 7B, is read out under the control of the storage controller 32 in the above-described manner, the micro scanning mirror 34 may sequentially scan, as shown in FIG. 7C, the image data in the first column, namely, the image data of ‘1’, ‘2’, ‘3’, and ‘4’ in a direction indicated by an arrow A, and may then sequentially scan the image data in the second column, namely, the image data of ‘4’, ‘3’, ‘2’, and ‘1’ in a direction indicated by an arrow \textcircled{2}. These scanning operations may be repeated for the remaining columns. Thus, in accordance with the present invention, there is no degradation in image brightness because, after the scanning of the image data of the n-th row in the original image 90 in the downward direction, the scanning of the image data of the n-th row in the symmetrical image 92 is repeated once.

Meanwhile, the method of storing and scanning an original image in the vertical scanning mode can be applied to the horizontal scanning mode in the same manner. That is, in the horizontal scanning mode, image data stored in a state of being horizontally symmetrical with the original image is read out in the order of rows so that they can be sequentially scanned in a direction from the left to the right and in a direction from the right to the left. Accordingly, there is no degradation in image brightness.

In accordance with the present invention, the transform/storage unit 30 transforms image data having an M-row×N-column size (M×N size) into image data having a 2M-row×N-column size (2M×N size). In this case, the image data having the 2M×N size is scanned once for a period that a vertical synchronizing signal is generated twice. Accordingly, it is possible to scan the original image, which has an M×N size, while maintaining desired image brightness.

In the image correction apparatus and method according to the present invention, image data is scanned in a vertical direction, using the micro scanning mirror 34, as described above. However, the present invention is not limited to the illustrated image correction apparatus and method. That is, the present invention may be implemented using a configuration different from that of FIG. 2. For example, the image correction apparatus of the present invention shown in FIG. 2 may dispense with the storage controller 32, as long as, after the scanning of image data in one column in the downward direction, the image data is again scanned in the upward direction. In this case, the image correction method shown in FIG. 6 dispenses with step 72.

The transform/storage unit 30 and storage controller 32 of the image correction apparatus according to the present invention, which are shown in FIG. 2, may be built in the video signal processor 10 shown in FIG. 1. In this case, image data read out from the transform/storage unit 30 can function as a control signal to control the emission of light from the light source 12 to the micro scanning mirror 34. The light source 12 may be arranged between the transform/storage unit 30 and the micro scanning mirror 34.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An image correction apparatus comprising:
a transform/storage unit for storing an original image consisting of image data having an M-row×N-column size, the transform/storage unit laterally reversing an order of the image data at intervals of one row, upon storing the original image, and storing the resultant image data of the original image; and
a micro scanning mirror for scanning the image data read out from the transform/storage unit.

2. The image correction apparatus according to claim 1, further comprising:
a storage controller for reading out, in a direction from the left to the right, the image data of an m-th row (1≦m≦M) in the image stored in the transform/storage unit, outputting the read image data to the micro scanning mirror, reading out, in the direction from the left to the right, the image data of an m+1-th row in the image stored in the transform/storage unit, and outputting the read image data to the micro scanning mirror.

3. The image correction apparatus according to claim 1, wherein, upon storing the original image, the transform/storage unit laterally reverses an order of the image data of each even row, and storing the resultant image data of the original image.

4. The image correction apparatus according to claim 1, wherein, upon storing the original image, the transform/storage unit laterally reverses an order of the image data of each odd row, and storing the resultant image data of the original image.

5. The image correction apparatus according to claim 1, wherein the laterally-reversed image data is scanned in a blanking period.

6. The image correction apparatus according to claim 1, wherein at least one of the transform/storage unit and the storage controller is included in a video signal processor for processing a video signal, and outputting the processed video signal to a light source.

7. An image correction apparatus comprising:
a transform/storage unit for storing an original image consisting of image data having an M-row×N-column size, together with a symmetrical image vertically symmetrical with the original image; and
a micro scanning mirror for scanning the image data read out from the transform/storage unit.

8. The image correction apparatus according to claim 7, further comprising:
a storage controller for reading out, in a downward direction, the image data of an n-th column (1≦n≦N) in the image stored in the transform/storage unit, outputting the read image data to the micro scanning mirror, reading out, in the downward direction, the image data of an n+1-th column in the image stored in the transform/storage unit, and outputting the read image data to the micro scanning mirror,
wherein the transform storage unit stores the symmetrical image, which consists of image data having the M-row×N-column size, beneath the original image having the M-row×N-column size such that the symmetrical image is vertically parallel to the original image while being adjacent to the original image.

9. The image correction apparatus according to claim 7, wherein at least one of the transform/storage unit and the storage controller is included in a video signal processor for processing a video signal, and outputting the processed video signal to a light source.

10. An image correction apparatus comprising:
a video signal processor for processing an original image consisting of image data having an M-row×N-column size such that an order of the image data is reversed at intervals of at least one row; and
a light source for outputting an image in accordance with results of the processing of the video signal processor.

11. The image correction apparatus according to claim 10, wherein the laterally-reversed image data is scanned in a blanking period.

12. The image correction apparatus according to claim 10, wherein the video signal processor comprises a transform/storage unit for storing the laterally-reversed image data.

13. The image correction apparatus according to claim 12, wherein the video signal processor further comprises a storage controller for reading out, in a direction from the left to the right, the image data of an m-th row (1≦m≦M) in the image data stored in the transform/storage unit, outputting the read image data to the light source, reading out, in the direction from the left to the right, the image data of an m+1-th row in the image data stored in the transform/storage unit, and outputting the read image data to the light source.

14. The image correction apparatus according to claim 10, further comprising:
a micro scanning mirror for scanning image data output from the light source.

15. An image correction method carried out in an image correction apparatus adapted to scan image data using a micro scanning mirror, comprising:
storing an original image consisting of image data having an M-row×N-column size after laterally reversing an order of the image data at intervals of one row; and
horizontally scanning the stored image data.

16. The image correction method according to claim 15, further comprising:
reading out the image data of an m-th row (1≦m≦M) in the stored image in a direction from the left to the right, reading out the image data of an m+1-th row in the stored image in the direction from the left to the right, and then proceeding to the scanning step.

17. An image correction method carried out in an image correction apparatus adapted to scan image data using a micro scanning mirror, comprising:
storing an original image consisting of image data having an M-row×N-column size, together with a symmetrical image vertically symmetrical with the original image; and
vertically scanning the stored image data.

18. The image correction method according to claim 17, further comprising:
reading out the image data of an n-th column (1≦n≦N) in the stored image data in a downward direction, reading out the image data of an n+1-th column in the stored image data in the downward direction, and proceeding to the scanning step,
wherein the storing step comprises storing the symmetrical image, which consists of image data having the M-row×N-column size, beneath the original image having the M-row×N-column size such that the symmetrical image is vertically parallel to the original image while being adjacent to the original image.

19. An image correction method comprising:
storing an original image consisting of image data having an M-row×N-column size such that an order of the image data is reversed at intervals of at least one row; and
outputting the image data of the stored image to a light source.

20. The image correction method according to claim 19, further comprising:
storing a symmetrical image vertically symmetrical with the original image, together with the original image.
